(19) United States
(12) Patent Application Publication
(10) Pub. No.: US 2019/0293219 A1
(43) Pub. Date: Sep. 26, 2019

(54) IRRIGATION BAYONET RISER PIPE AND RISER PIPE RECEIVING BASE ASSEMBLY

(71) Applicant: MIKE DELAYNE FRIESEN, BUHL, ID (US)

(72) Inventor: MIKE DELAYNE FRIESEN, BUHL, ID (US)

(21) Appl. No.: 16/362,646

(22) Filed: Mar. 23, 2019

Related U.S. Application Data
(60) Provisional application No. 62/647,256, filed on Mar. 23, 2018.

(51) Int. Cl. F16L 37/107; F16L 25/06; F16L 37/248

(52) U.S. Cl. CPC F16L 37/107; F16L 37/248; F16L 25/06

(57) ABSTRACT

An irrigation bayonet riser pipe and riser receiving base assembly reduces the labor required to farm agricultural plots. The invention comprises a plurality of riser pipe receiving bases distributed along and fluidly connected to an underground irrigation supply line and a respective plurality of bayonet riser pipes that are selectively and fluidly connected to said receiving bases and further incorporates a respective plurality of flexible shape retaining and durable tubular irrigation hose segments that are attached to said receiving bases and each said hose segment preserves a path to a respective said receiving base through the ground to allow said riser pipes to be inserted and reversibly attached through said hose segments to said receiving bases. When said riser pipes are removed from said bases, a worker is better able to use farm equipment on the plot to till, to plant, and to harvest crops.

### CROSS-REFERENCE TO RELATED APPLICATIONS

This application claims the benefit of provisional patent application No. 62/647,256 filed Mar. 23, 2018.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

### Field of the Invention

The present invention relates to a novel irrigation bayonet riser pipe and riser receiving base assembly 6 that when used reduces the amount of labor required to irrigate and farm small and odd-shaped plots of irrigated agricultural land. In the past and to the present, these plots often were or are irrigated with above ground manual hand lines having a plurality of fixed riser pipes attached to segmented above ground water supply pipes. During a typical farming season, such hand lines generally would need to be manually placed and moved a number of times on and off the plot to allow workers and farm equipment better access to the plot during tilling, planting and harvesting operations regarding the crops being grown on the plot.

When the present invention is utilized to irrigate a plot, generally a plurality of riser pipe receiving bases 40 and or 42 of the present invention are distributed along and operationally and fluidly connected to an underground irrigation supply line 9 and a respective plurality of irrigation bayonet riser pipes 10 are selectively, reversibly, and fluidly connected to said plurality of receiving bases. When better access to the plot is needed, the water supply line does not need to be moved, but rather can be turned off and said plurality of riser pipes may be selectively removed to allow greater unimpeded access to the ground surface of the plot for tilling, planting, and harvesting operations or other desired activities.

The present invention incorporates a respective plurality of generally cylindrical flexible shape retaining and durable tubular irrigation hose segments 60 that are attached to respective said receiving bases and each respective said hose segment preserves a path to said receiving base through the ground under which said bases and said supply line are buried to allow said riser pipes to be efficiently inserted and reversibly attached through said respective protective hose segments to said receiving bases. When said riser pipes are removed from said bases, a farmer or other worker is better able to use farm equipment on the plot to till the ground, to plant, and to harvest crops. When the riser pipes are disconnected and removed from the hose segments, the hose segments 60 preserve the paths for later selective insertion and reconnection of said riser pipes after the farming activities that required said pipes to be removed are completed.

The present invention lessens the manual labor traditionally needed to irrigate and farm small and odd-shaped farm plots such as the corners of circular pivot irrigated fields by providing a system that is easier to use than the traditional hand land lines.

### BRIEF SUMMARY OF THE INVENTION

A principal objective of the invention is to provide an improved irrigation system that provides irrigation to small and odd-shaped plots that is simple, low-maintenance, and reliable. Use of the invention in a farm plot allows better and more efficient access to the farm plot surface for farming activities such as tilling, planting, and harvesting over said receiving bases when the riser pipes are removed from said bases.

Additional and various other objects and advantages attained by the invention will become more apparent as the specification is read and the accompanying figures are reviewed.

### BRIEF DESCRIPTION OF THE SEVERAL VIEWS OF THE DRAWING

FIG. 1 is a side view of an irrigation bayonet riser pipe and riser receiving base assembly 6 extending above an agricultural farm plot and having a receiving base 40 that is attached to an irrigation supply line 9 showing the relationship between a ground surface plane 8 of plot of irrigated agricultural land and the invention;

FIG. 2 is a partially exploded side view of the assembly shown in FIG. 1 with an irrigation bayonet riser pipe 10 positioned above an agricultural farm plot and an alternative receiving base 42 attached to an irrigation supply line 9 showing the relationship between the ground surface plane of the plot and the invention;

FIG. 3 is a side view of an elongated hollow irrigation bayonet riser pipe 10 having a riser main tube 12 and a central riser water bore 14;

FIG. 4 is an enlarged, side view of an indicated portion of FIG. 3 showing two retention rod slots 18 and two retention detents 20 and a resilient O-ring 26 placed in an O-ring groove 24;

FIG. 5 is a perspective view of a lower portion of said riser pipe shown in FIG. 3 showing said bayonet slots 18;

FIG. 6 is an exploded view showing a preferred embodiment of a riser pipe receiving base 40 and a flexible irrigation hose segment 60;

FIG. 7 is a side view of the components shown in FIG. 6 assembled and operatively connected to a water supply line 9 preferably by threaded attachment to a T-fitting or other suitable port;

FIG. 8 is a partially exploded cross-sectional view of the assembly shown in FIG. 7 showing a transverse retention rod 52 and showing a flow reducing bushing 54 that can selectively be placed and retained in a lower portion of a tubular irrigation water conduit bore 45 to restrict water flow through said receiving base;

FIG. 9 is a side view of a cylindrical debris excluder 80;

FIG. 10 is an exploded view showing an alternative embodiment of a riser pipe receiving base 42 and a flexible irrigation hose segment 60;

FIG. 11 is a side view of the components shown in FIG. 10 shown assembled;

FIG. 12 is a cross-sectional view of said receiving base 42 and said hose segment 60 shown in FIG. 11 showing a transverse retention rod 52 and showing a flow reducing lower irrigation water conduit bore 45′ that restricts water flow through said receiving base;

FIG. 13 is a cross-sectional view of the assembly shown in FIG. 11 and showing an irrigation bayonet riser pipe 10 partially inserted within said hose segment 60 and within an alternative central receiving bore 49′ with said retention rod 52 below said slots 18;

FIG. 14 is a cross-sectional view of the assembly shown in FIG. 11 and showing an irrigation bayonet riser pipe 10 inserted within said hose 60 and within said base 42 with said retention rod 52 within said slots 18 and showing said O-ring 26 in sealing cooperation with said bore before rotation of said pipe about its longitudinal axis to engage said retention detents 20;

FIG. 15 is a cross-sectional view of the assembly shown in FIG. 14 and showing said irrigation bayonet riser pipe 10 inserted within said hose segment 60 and within said base 42 with said retention rod 52 within said slots 18 after rotation of said pipe about its longitudinal axis to engage said retention detents 20;

FIG. 16 is a partially exploded perspective view of a ball-shaped debris excluder 70 positioned above an open upper end of a hose segment 60 (said excluder could be an over-sized tennis ball or similar ball-shaped object);

FIG. 17 is a perspective view of said debris excluder 70 shown in FIG. 16 positioned within said hose segment 60 with said excluder positioned to guard the interior of said hose segment from potential intruding soil and debris arising from farming operations;

FIG. 18 is a partially exploded perspective view of a cylindrical debris excluder 80 positioned above an open upper end of a hose segment 60 (said excluder preferably is a closed-cell flexible foam rubber rod that is sized to be reversibly inserted into said hose segment to fill most of the interior volume of said hose segment when no riser pipe is within said hose segment);

FIG. 19 is a perspective view of a cylindrical debris excluder 80 shown in FIG. 18 positioned within said hose segment 60 with said excluder positioned to guard the interior of said hose segment from potential intruding soil and debris;

FIG. 20 is a partially exploded side view of a riser pipe receiving base 42 and a hose segment 60 and showing a cylindrical debris excluder 80 positioned above an open upper end of a hose segment;

FIG. 21 is a side view of said riser pipe receiving base 42, said hose segment 60, and said debris excluder 80 shown in FIG. 20 and showing said cylindrical debris excluder 80 positioned within said hose segment after removal of a riser pipe with said excluder positioned to guard the interior of said hose segment from potential intruding soil and debris generated or stirred up by farming operations over the hose segment;

FIG. 22 is a side view of said hose segment and said cylindrical debris excluder 80 shown in FIG. 20 after a tilling operation and showing an elevated ground surface plane 8 that results from said tilling operations on the plot and over the hose segments and receiving bases of the invention and showing said plane overtopping said excluder positioned within said hose segment 60 after removal of a riser pipe; and

FIG. 23 is a side view of said hose segment and said cylindrical debris excluder shown in FIG. 22 and showing said cylindrical debris excluder partially extending upward and out of said hose segment resulting from an application of pressurized irrigation water from below said excluder from a water supply line 9. After removal of the debris excluder and perhaps minor adjustment of the upper portion of a hose segment, reinsertion and attaching of a riser pipe can be accomplished.

### DETAILED DESCRIPTION OF THE INVENTION

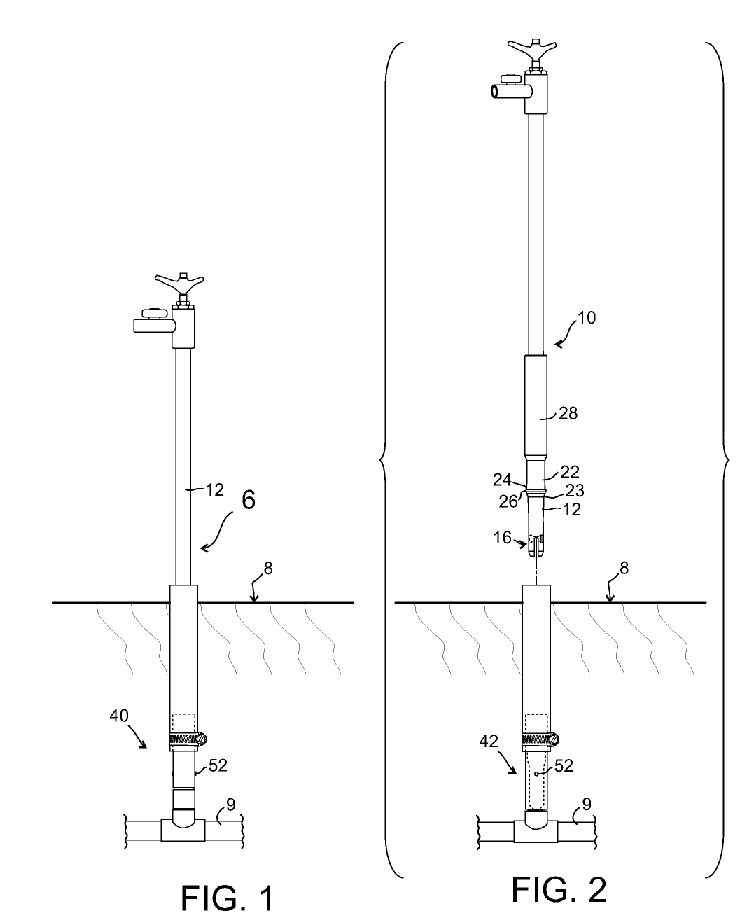

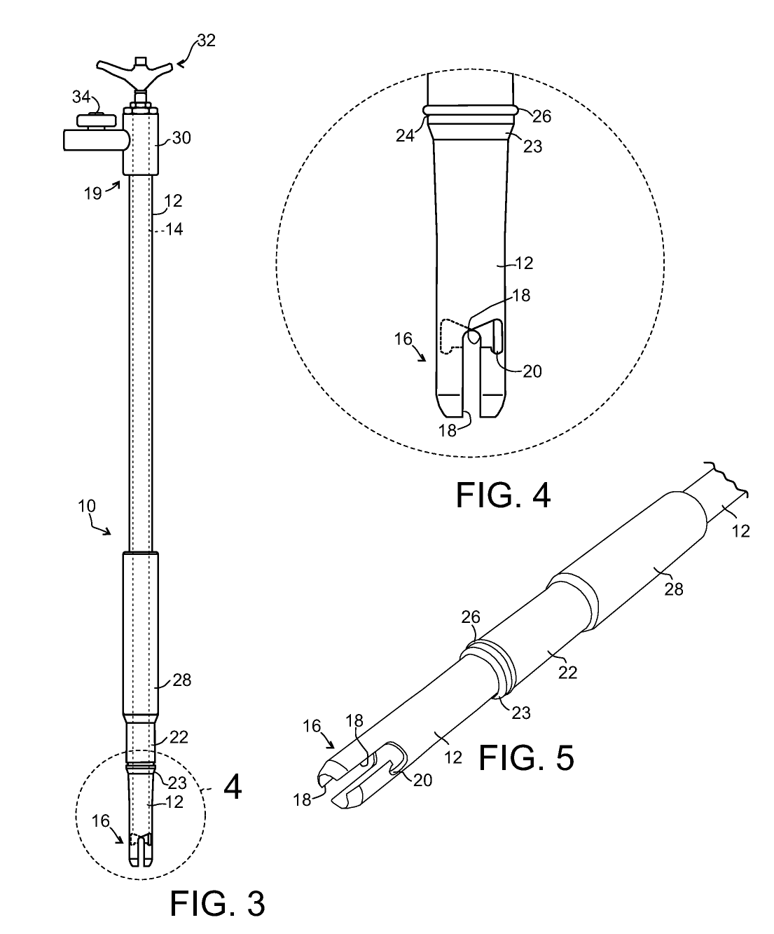

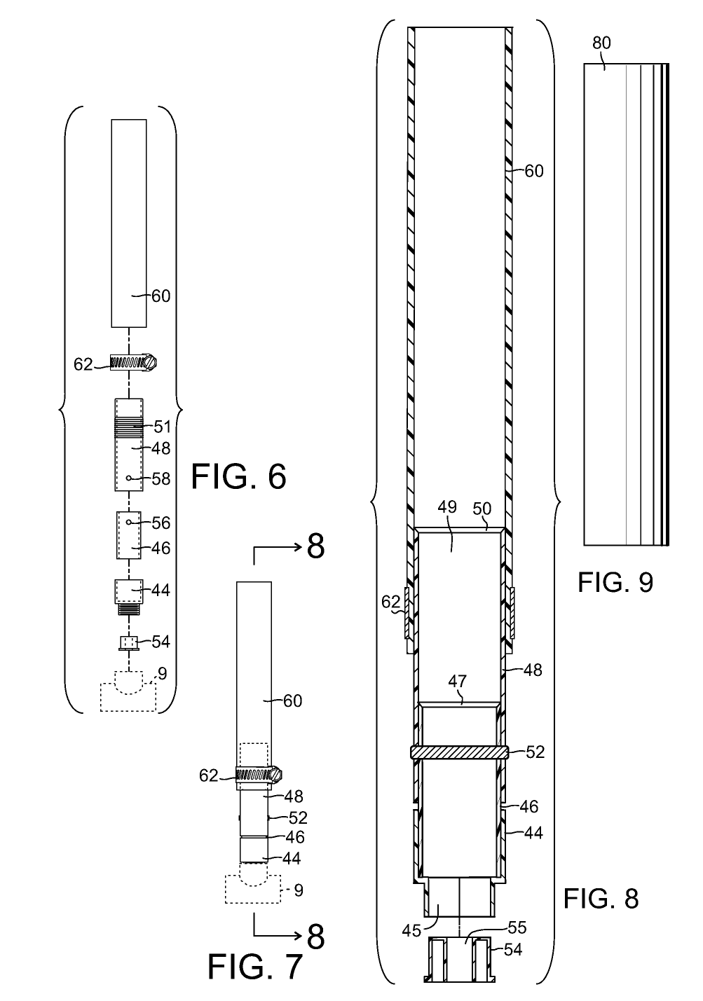

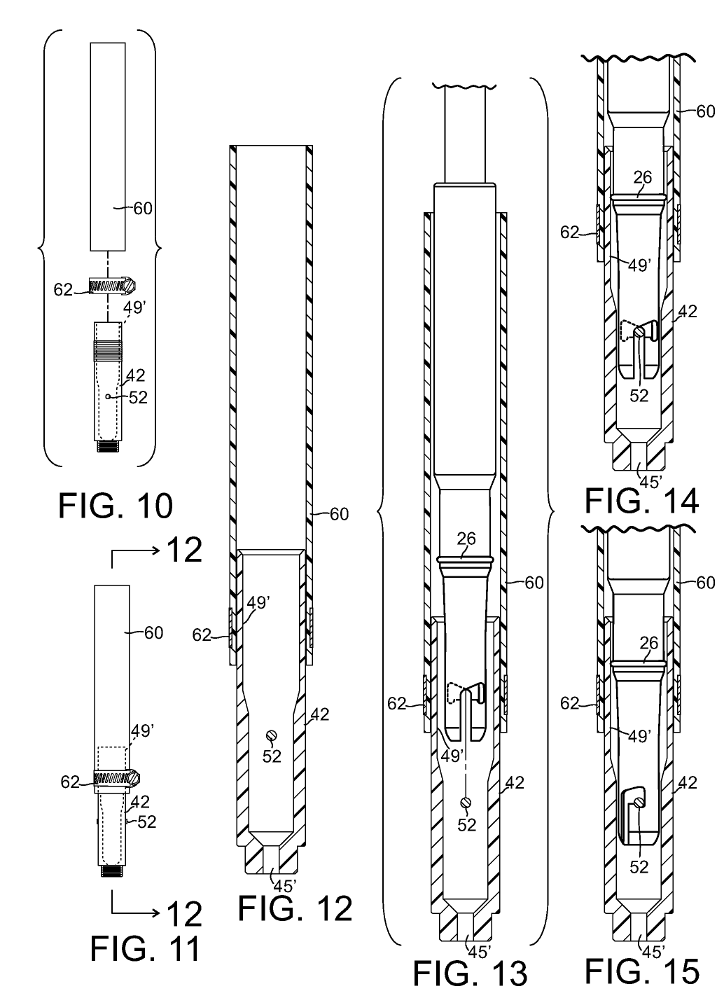

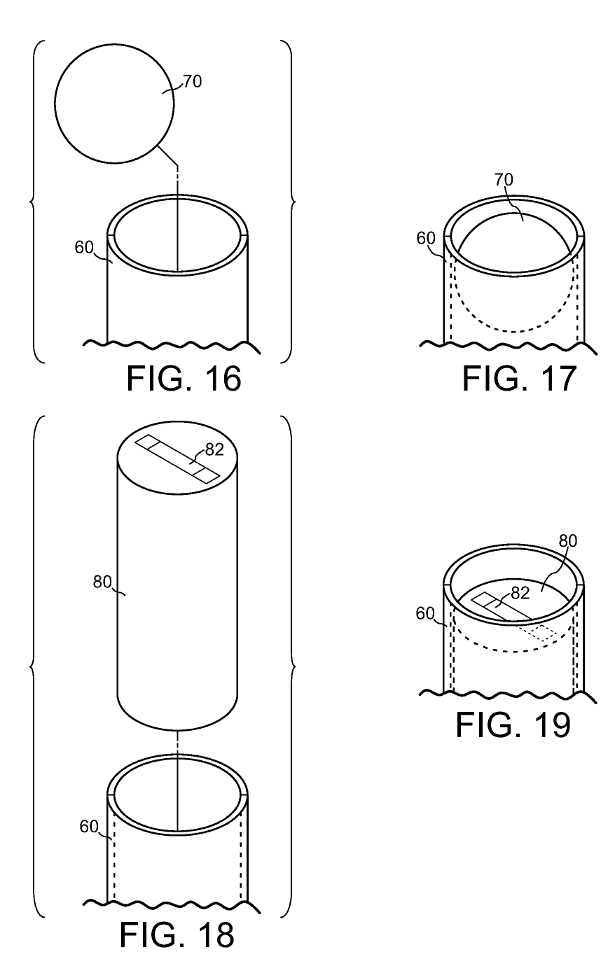

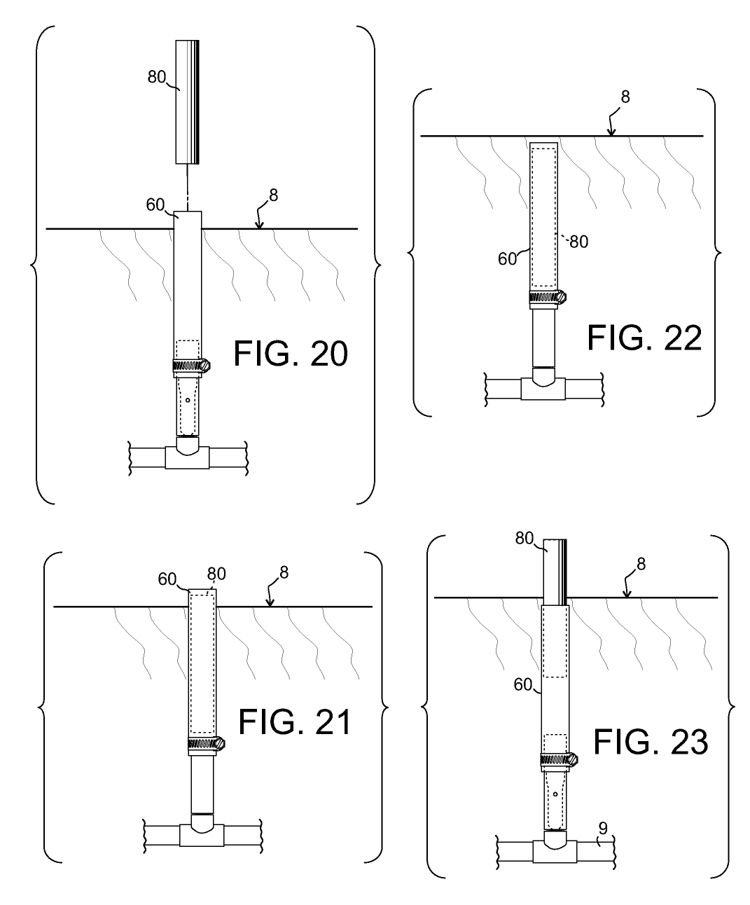

Referring to FIGS. 1 to 23, the present invention is a novel irrigation bayonet riser pipe and riser receiving base assembly 6 for fluid connection to an underground irrigation supply line 9 that allows a more convenient and labor saving system of irrigation that lessens the labor needed to farm and irrigate small and odd-shaped farm plots.

The elements of the invention, an irrigation bayonet riser pipe and riser receiving base assembly 6 for fluid connection beneath the ground surface plane 8 of a plot of irrigated agricultural land to an underground water supply line 9 comprising an irrigation bayonet riser pipe 10 having a riser main tube 12, a central riser water bore 14, and a lower bayonet end 16, said bayonet end preferably having a beveled bottom and having a pair of opposed retention rod slots 18 extending from said bayonet end longitudinally toward an upper main tube end 19 and preferably each said slot respectively having an offset rod retaining detent 20 formed to receive and retain a cooperating riser pipe retention rod 52 of a riser pipe receiving base 40, 42, preferably an annular elongated inner tube spacer 22 surrounds and is attached to a central longitudinal portion of said main tube and said inner tube spacer having a beveled lower edge 23 and an annular O-ring receiving groove 24 in close proximity to said beveled lower edge; a resilient sealing O-ring 26 is mounted in said receiving groove and closely encircles the outside surface of said inner tube spacer above said slots, said O-ring sized to sealingly cooperate with a central receiving bore of said receiving base 49, 49′; preferably an annular elongated outer tube spacer 28 coaxially surrounds and is attached to a central longitudinal portion of said inner tube spacer; preferably a T-fitting 30 is fluidly attached to said upper main tube end; preferably a suitable sprinkler head 32 is fluidly connected to either said upper main tube end or to said T-fitting; preferably a water discharge valve 34 is fluidly connected to and communicates with said central riser bore; said riser pipe receiving base 40 comprising a male adapter fitting 44 having an upper open-ended, longitudinal, and tubular irrigation water conduit bore 45 there through; a tubular coupler sleeve 46 preferably having a beveled upper sleeve edge 47 and having a generally uniform circular cross-section received within and coaxially connecting said water conduit bore to a lower portion of an open-ended tubular upper riser base end 48 having a generally uniform circular cross-sectional central receiving bore 49 and a beveled upper riser base edge 50, preferably a plurality of friction grooves 51 encircle an upper outer portion of said upper riser base end; a transverse riser pipe retention rod 52 is mounted transverse and across the longitudinal axis of said upper riser base end; preferably a flow reducing bushing 54 having a reducing bushing bore 55 is mounted in said conduit bore; a sleeve rod retention bore 56 formed to cooperate with a coaxial tube rod retention bore 58 to receive and retain said riser pipe retention rod; an alternative embodiment of said riser pipe receiving base 42 having an alternative conduit bore 45′ and an alternative central receiving bore 49′; a durable flexible shape-retaining irrigation hose segment 60 attached to said base coaxial to said central receiving bore 49, a hose clamp 62 to secure said hose segment to said receiving base; and preferably a ball-shaped debris excluder 70 or a cylindrical debris excluder 80 having an excluder strap 82.

The invention is preferably made from common PVC pipes, flexible rubber shape-retaining water discharge hoses or pipes, PVC plumbing fittings or other suitable irrigation system materials, hoses, and pipes. Means of joining, connecting, or attaching of elements of the invention one to another preferably may include solvent welding, adhesive, threaded cooperating portions of elements to be joined, connected, or attached one to another, hose clamps, and bayonet type slotted reversible connections between said riser pipes and said respective receiving bases.

The preceding description and exposition of a preferred embodiment of the invention is presented for purposes of illustration and enabling disclosure. It is neither intended to be exhaustive nor to limit the invention to the precise form disclosed. Modifications or variations in the invention in light of the above teachings that are obvious to one of ordinary skill in the art are considered within the scope of the invention as determined by the appended claims when interpreted to the breath to which they are fairly, legitimately and equitably entitled.

I claim:

1. An irrigation bayonet riser pipe and riser receiving base assembly for fluid connection to an underground water supply line comprising an irrigation bayonet riser pipe reversibly and coaxially inserted into through and retained within a tubular hose segment and reversibly attached coaxial to a riser pipe receiving base, and said receiving base fluidly connected to said supply line.

2. An irrigation bayonet riser pipe and riser receiving base assembly allowing for quick reversible and fluid connection to an underground water supply line comprising an irrigation bayonet riser pipe having a riser main tube having a central riser water bore, said riser pipe reversibly inserted within a flexible shape-retaining tubular hose segment and attached to a riser pipe receiving base having a central receiving bore and a water conduit bore, said hose segment attached to said receiving base, said conduit bore in fluid connection to a water supply in said supply line and said bores all in fluid communication and continuity when said riser pipe attached to said receiving base.

3. An irrigation bayonet riser pipe and riser receiving base assembly in accordance with claim 2 wherein said bayonet riser pipe further comprising a

4. A process of irrigating an odd-shaped or small agricultural plot comprising the following steps:
A. select an odd-shaped or small agricultural plot for irrigation;
B. operationally connect an irrigation bayonet riser pipe and riser pipe receiving base assembly to an operational underground water supply line in said plot, said assembly having a bayonet riser pipe reversibly and fluidly connected to a riser pipe receiving base;
C. ensure water in the water supply line is turned off;
D. disconnect and remove said bayonet riser pipe from said riser receiving base;
E. insert a debris excluder in said receiving base in place of said riser pipe;
F. perform one or more selected farming activities over or in the vicinity of said riser receiving base;
G. ensure water in the irrigation supply line is turned on;
H. check for and remove said debris excluder and any debris from each said receiving base; and
I. insert and reversibly secure said riser pipe in said receiving base.
